(19) United States
(12) Patent Application Publication
(10) Pub. No.: US 2014/0237357 A1
(43) Pub. Date: Aug. 21, 2014

(54) TWO-DIMENSIONAL DOCUMENT NAVIGATION

(71) Applicant: Google Inc., Mountain View, CA (US)

(72) Inventors: Cayden Meyer, New South Wales (AU); Ian Kilpatrick, New South Wales (AU)

(73) Assignee: Google Inc., Mountain View, CA (US)

(21) Appl. No.: 14/134,376

(22) Filed: Dec. 19, 2013

Related U.S. Application Data
(60) Provisional application No. 61/767,230, filed on Feb. 20, 2013.

(51) Int. Cl. G06F 17/21

(52) U.S. Cl. CPC G06F 17/212
USPC 715/273

(57) ABSTRACT

A method includes receiving a first user input signal requesting a document preview view and outputting for display the document preview view including an active document representation of content from a first document that is designated as an active document, wherein a first portion of the active document representation is visible in the document preview view. The method also includes receiving a second user input signal. In response to determining that the second user input signal corresponds to a document navigation request, the method includes repositioning the active document representation such that a second portion of the active document representation is visible in the document preview view. In response to determining that the second user input signal corresponds to a document change request, the method includes designating the second document as the active document.

### CROSS-REFERENCE TO RELATED APPLICATIONS

This application claims the benefit of U.S. Provisional Application Ser. No. 61/767,230, filed on Feb. 20, 2013, which is incorporated herein in its entirety by reference.

### BACKGROUND

Many software applications allow users to store and organize multiple documents. As one example, desktop computer operating systems often incorporate a file manager, which is a user interface that facilitates interaction with the file system of the operating system. As another example, online document storage systems allow users to create or store documents at a remote server, access the files via a network such as the internet using an interface provided via a web browser or an application, and in some examples, edit the file using an online file creation and editing system that is associated with the online document storage system. In both desktop and online systems for storing and organizing documents, files can be organized into collections or lists, based on directory structures and/or attributes. In another example, multiple documents can be organized by being attached to an electronic mail message, where a user interface for the electronic mail message includes a list of the attached files.

Some software applications that store and organize documents include file preview capabilities. For example, electronic documents can be displayed to a user on a “slider” or a “moving carousel” with a smooth sliding or scrolling effect. When navigating through multiple electronic documents, however, a user often has to open each document in a new tab to preview multiple pages within that document.

### SUMMARY

The disclosure relates to two-dimensional document navigation.

One aspect of the disclosed embodiments is a method that includes receiving a first user input signal requesting a document preview view of a plurality of documents from a document list that includes at least a first document and a second document, wherein the first document is designated as an active document, and in response to the first user input signal, outputting for display the document preview view including an active document representation of content from the first document, wherein a first portion of the active document representation is visible in the document preview view. The method also includes receiving, while the preview view is displayed, a second user input signal, and determining whether the second user input signal corresponds to a document navigation request or a document change request. In response to determining that the second user input signal corresponds to the document navigation request, the method includes repositioning the active document representation such that a second portion of the active document representation is visible in the document preview view. In response to determining that the second user input signal corresponds to the document change request, the method includes designating the second document as the active document.

Another aspect of the disclosed embodiments is a non-transitory computer-readable storage device including program instructions executable by one or more processors that, when executed, cause the one or more processors to perform operations. The operations include receiving a first user input signal requesting a document preview view of a plurality of documents from a document list that includes at least a first document and a second document, wherein the first document is designated as an active document, and in response to the first user input signal, outputting for display the document preview view including an active document representation of content from the first document, wherein a first portion of the active document representation is visible in the document preview view. The operations also include receiving, while the preview view is displayed, a second user input signal, and determining whether the second user input signal corresponds to a document navigation request or a document change request. In response to determining that the second user input signal corresponds to the document navigation request, the operations include repositioning the active document representation such that a second portion of the active document representation is visible in the document preview view. In response to determining that the second user input signal corresponds to the document change request, the operations include designating the second document as the active document.

Another aspect of the disclosed embodiments is an apparatus that includes one or more processors and one or more memory devices for storing program instructions used by the one or more processors. The program instructions, when executed by the one or more processors, cause the one or more processors to receive a first user input signal requesting a document preview view of a plurality of documents from a document list that includes at least a first document and a second document, wherein the first document is designated as an active document, and in response to the first user input signal, output for display the document preview view including an active document representation of content from the first document, wherein a first portion of the active document representation is visible in the document preview view. The program instructions further cause the one or more processors to receive, while the preview view is displayed, a second user input signal and determine whether the second user input signal corresponds to a document navigation request or a document change request. In response to a determination that that the second user input signal corresponds to the document navigation request, the program instructions cause the one or more processors to reposition the active document representation such that a second portion of the active document representation is visible in the document preview view. In response to a determination that that the second user input signal corresponds to the document change request, the program instructions cause the one or more processors to designate the second document as the active document.

### BRIEF DESCRIPTION OF THE DRAWINGS

The description here makes reference to the accompanying drawings wherein like reference numerals refer to like parts throughout the several views, and where:

FIG. 1 is a block diagram showing an example of a computing device;

FIG. 2 shows a first example user interface for two-dimensional document navigation outputting a representation of a first document;

FIG. 3 shows the first example user interface for two-dimensional document navigation outputting a representation of a second document in a first position;

FIG. 4 shows the first example user interface for two-dimensional document navigation outputting a representation of a second document in a second position;

FIG. 5 is a flow chart showing an example process for two-dimensional document navigation;

FIG. 6 shows a second example user interface for two-dimensional document navigation outputting an active document representation including content from of a first document in a first position;

FIG. 7 shows the second example user interface for two-dimensional document navigation outputting the active document representation including content from of a first document in a second position;

FIG. 8 shows the second example user interface for two-dimensional document navigation outputting the active document representation including content from of a second document; and

FIG. 9 shows an example of an environment in which a system for two-dimensional document navigation can be implemented.

### DETAILED DESCRIPTION

Two-dimensional document navigation can be used to allow a user to quickly view and navigate multiple documents and multiple pages within each document within a single user interface without opening each document independently in a document viewer application. In one example, the user can scroll left or right to navigate between different documents, or scroll up or down to view different pages within each document. In another example, navigation arrows such as “left”, “right”, “up” and “down” can be provided on the screen.

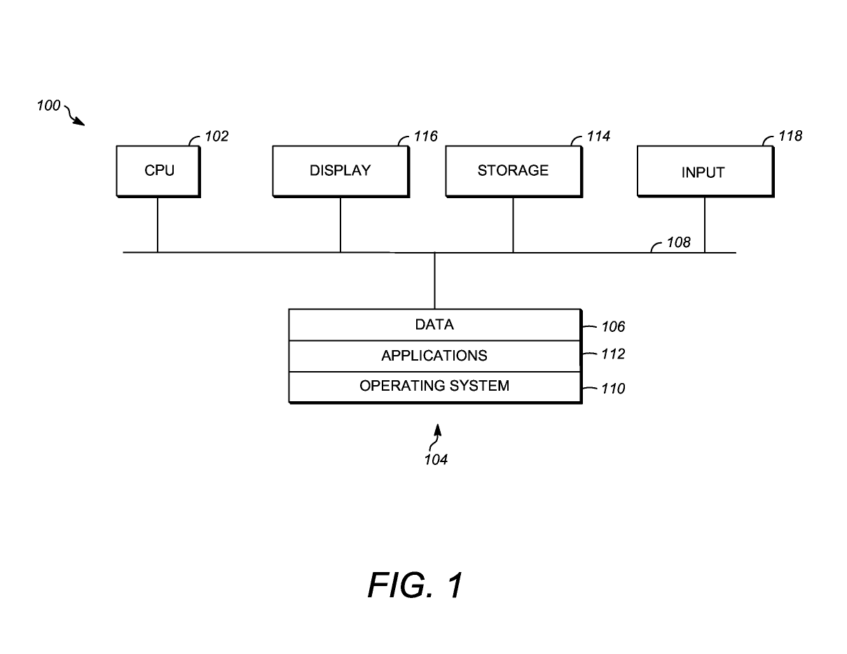

FIG. 1 is a block diagram of a computing device 100. The computing device 100 can be any type of handheld or desktop device in the form of a single computing device, for example, a smartphone, a laptop computer, a notebook computer, a desktop computer, a mobile telephone, a tablet, a PDA, and the like.

The CPU 102 in the computing device 100 can be a conventional central processing unit. Alternatively, the CPU 102 can be any other type of device, or multiple devices, capable of manipulating or processing information now-existing or hereafter developed. Although the disclosed embodiments can be practiced with a single processor as shown, e.g. CPU 102, advantages in speed and efficiency can be achieved using more than one processor.

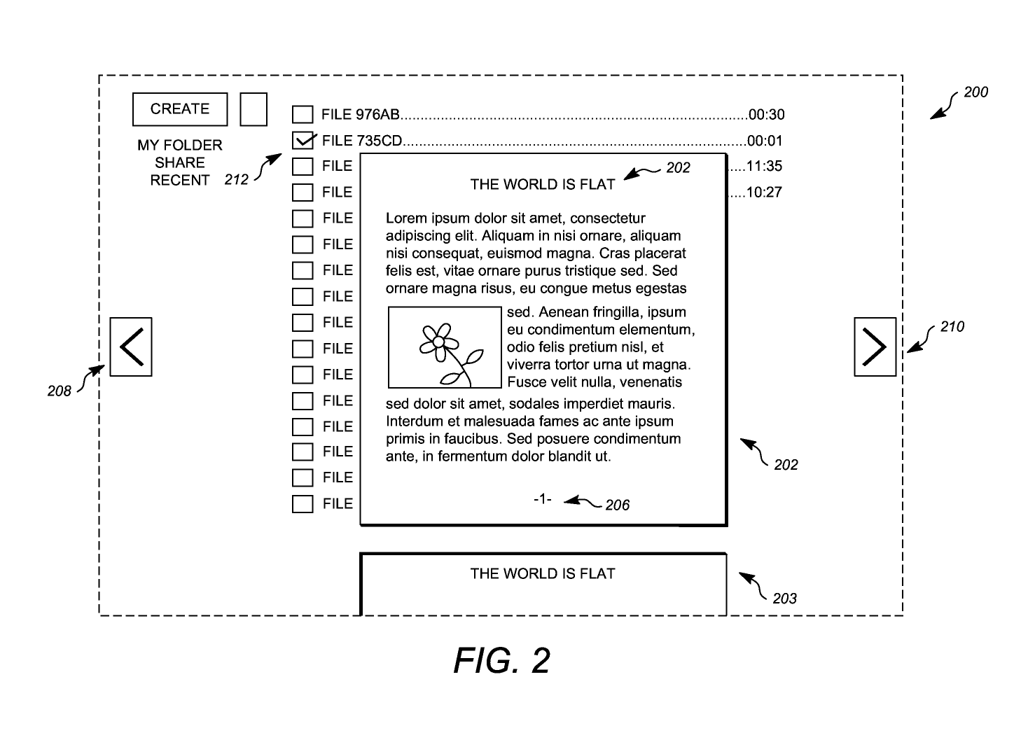

The memory 104 in the computing device 100 can be a random access memory device (RAM). Any other suitable type of storage device can be used as the memory 104. The memory 104 can include code and data 106 that is accessed by the CPU 102 using a bus 108. The memory 104 can also include an operating system 110 and installed applications 112, the installed applications 112 including programs that permit the CPU 102 to perform the methods described here. For example, the installed applications 112 can include the two-dimensional document navigation applications described in FIGS. 2-5. The computing device 100 can also include secondary storage 114, which can, for example, be a memory card, external memory, a flash drive, or any other form of suitable computer readable medium. Because the installed applications 112 can contain a significant amount of information, they can be stored in whole or in part in the secondary storage 114 and loaded into the memory 104 as needed for processing.

The computing device 100 can include one or more output devices, such as display 116. The display 116 can be a liquid crystal display (LCD), a cathode-ray tube (CRT), or any other type of display that allows output to be presented to a user, for example, in response to receiving a video signal. The computing device 100 can also include an input device 118, such as a keyboard, a mouse, a touch sensitive device, or a gesture sensitive input device that can receive user inputs and can output signals or data indicative of the user inputs to the CPU 102.

Although FIG. 1 depicts the CPU 102 and the memory 104 of the computing device 100 as being integrated into a single unit, other configurations can be utilized. The operations of the CPU 102 can be distributed across multiple machines (each machine having one or more of processors) which can be coupled directly or across a local area or other network. The memory 104 can be distributed across multiple machines such as network-based memory or memory in multiple machines performing the operations of computing device 100. Although depicted here as a single bus, the bus 108 of the computing device 100 can be composed of multiple buses. Further, the secondary storage 114 can be directly coupled to the other components of the computing device 100 or can be accessed via a network and can comprise a single integrated unit such as a memory card or multiple units such as multiple memory cards. The computing device 100 can thus be implemented in a wide variety of configurations.

FIG. 2 shows an interface screen 200 of a first example user interface for two-dimensional document navigation outputting a page from a document. The interface screen 200 can be output for display in the form a signal that is generated, for example by the CPU 102 of the computing device 100 which, when transmitted to the display 116 of the computing device 100, causes the interface screen 200 to be displayed at the display 116.

The interface screen 200 includes a representation of an electronic document (referred to as document hereinafter), the representation including content from a first page 202 of document and content from a second page 203 of the document. The representation of the document, including the first page 202 and the second page 203 is an active document representation, meaning that user interface actions can be taken with respect to it, such as a document navigation request for changing the portion of the document that is currently displayed in the interface screen 200, as will be explained further herein. The first page 202 includes a document heading 204 (“The World Is Flat”) as well as text, a flower picture, and a page number 206 (“-1-”). The interface screen 200 can also include a menu, which is displayed on the left side of the interface screen 200 and to the left of the representation of the document.

In some implementations, a plurality of documents including the first document and a second document can be organized as a list of documents, such as the list of documents displayed on interface screen 200 behind the active document representation. In such implementations, the active document representation is a portion of a document preview view that can be output for display in response to a user input signal based on an input made with respect to the list of documents, such as selection of a document from the list of documents, or clicking an interface button that is associated with the list of documents and represents a request for the document preview view. The list of documents can include attributes such as, for example, an indicator box, a document identifier, and time the document was last saved. In some implementations, the documents in the list can also be displayed within the document preview view as inactive document representations on a “moving carousel” or a “slider” such that the documents can be navigated with a smooth sliding or scrolling effect. For example, when a document is selected by the user, the document can gradually slide or scroll onto the screen (or scene). The duration, speed, direction of transitions or other visual effects can be defined for the moving carousel or slider.

The interface screen 200 of FIG. 2 can include features such as two-dimensional document navigation in the document preview view, which allows a user to navigate between multiple documents and/or multiple pages within the documents. Two-dimensional document navigation within the document preview view can be initiated automatically upon opening or creation of a document. Two-dimensional document navigation in the document preview view can also be initiated by the user selecting an indicator, for example, checking a box (for example, box 212) next to a document identifier (for example, “File 735CD”).

The interface screen 200 can include interface elements for two-dimensional navigation in the document preview view. For example, a left arrow 208 and/or a right arrow 210 allow a different document to be designated as the currently active document. Thus, clicking on the left arrow 208 can cause a previous document from the document list to be designated as the currently active document, while clicking on the right arrow 210 can cause a subsequent document from the document list to be designated as the currently active document, navigation between different documents, or an up arrow or a down arrow (not shown), which allows navigation between different pages within the same document. Other user inputs can also include, for example, scrolling up or down, scrolling left or right, swipe or other user input indications. Thus, swiping left or right with respect to a gesture-sensitive input device can cause a different document to be designated as the currently active document, while swiping up or down can cause scrolling within the currently active document thereby causing a different portion of content from the currently active document to be displayed within the interface screen 200.

Two-dimensional document navigation can include receiving a user input within the document preview view and determining whether the user input corresponds to a document navigation request or a document change request. The document navigation requests indicates that the user wishes to view a different portion of the content from the currently active document, such as by moving the document representation for the currently active document with respect to the interface screen 200 such that a different portion of the document representation is visible within the interface screen 200. The document change request indicates that the user wishes a different document to be designated as the currently active document, such that multiple pages from the different document can be previewed within the document preview view and such that document navigation requests can be made with respect to that document.

The document navigation request can indicate a selection of a different page within the active document, or cause scrolling of the document representation for the active document. For example, a user swiping or scrolling down on the document representation for the currently active document can cause a different page of the currently active document, such as the second page 203, to be displayed on interface screen 200.

The document change request can indicate designation of a different document as the current active document. As examples, checking box 212, clicking the left arrow 208, or clicking the right arrow 210 can each cause a different document to be designated as the currently active document.

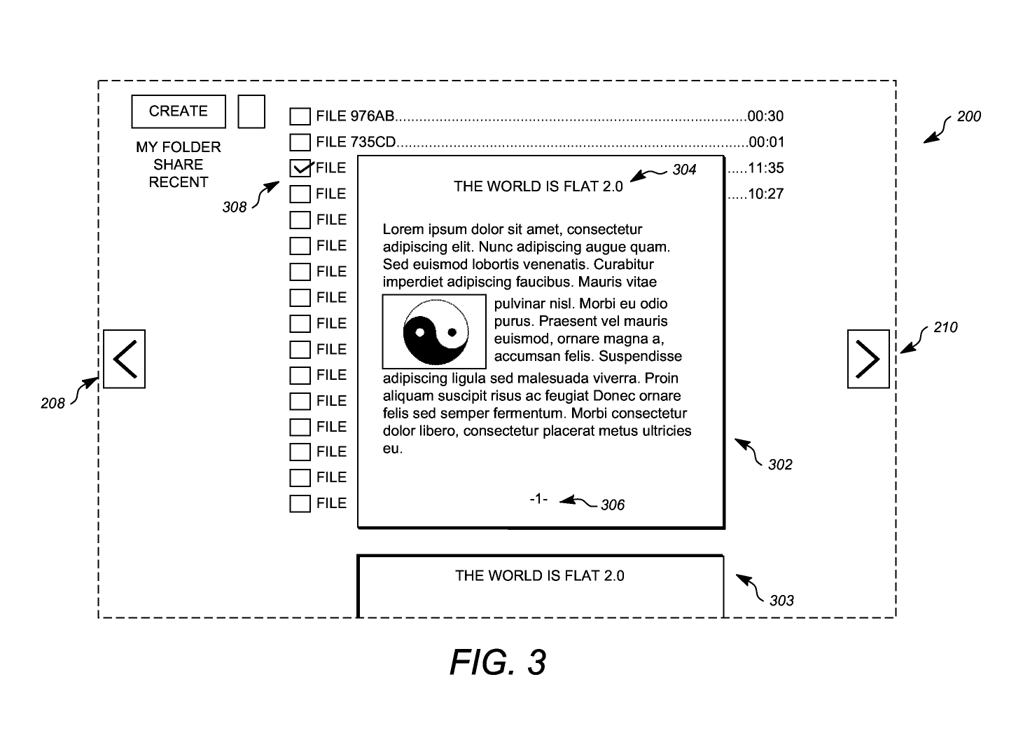

Upon receiving a document change request from within the document preview view of the interface screen 200 in FIG. 2, such a user clicking on the right arrow 210, a second document that appears below the currently active document in the document list, indicated by check 308, is designated as the new currently active document. In response, the active document representation is updated to include content from the second document, such as content from a first page 302 and a second page 303 of the second document, as shown in FIG. 3. While the document preview view remains displayed by the interface screen 200, the active document representation remains the focus of user inputs, thus document navigation requests now cause a different portion of the second document to be represented by the active document representation, as will be explained further herein.

In this example, all of the content from the first page 302 of the second document is included in the portion of the active document representation that is viewable within the document preview view and part, but not all, of the content from the second page 303 of the second document is included in the portion of the active document representation that is viewable within the document preview view. The second document includes, on the first page 302 thereof, a document heading 304 (“The World Is Flat 2.0”), text, a “Taoism” picture, and a page number 306 (“-1-”).

In some implementations, changing the active document, as described with respect to FIGS. 2-3, can cause the document representations for the first and second document to move within, into, and/or out of the interface screen 200 with a moving carousel or slider type view.

If an input representing a document navigation request is received while the preview view shown in FIG. 3 is displayed by the interface screen 200, the active document representation can be moved with respect to the interface screen 200 or updated such that a different portion of content from the currently active document is displayed within the interface screen 200. The input can be, for example, a key press, a mouse click on an interface element such as a down arrow (not shown), or a gesture in a top-to-bottom direction with respect to a gesture sensitive input device. In this example, the active document representation includes content from the second document, with all of the first page 302 and part but not all of the second page 303 being visible on the interface screen 200. When the user scrolls down, the position of the document representation is changed with respect to the interface screen 200 such that the visible portion of the content from the document changes. In one implementation, the position of the document representation is changed by scrolling the document representation in increments that are less than a full page. As an example, with respect to a document representation including lines of text, the scrolling increment can be one or more lines of text. As another example, scrolling can be performed by fractions of a page, such as one eighth of a page. As another example, scrolling need not correspond to a set increment, but can be dependent upon duration or magnitude of a user input signal, such as the length of travel of a gesture input. In other implementations, scrolling can be performed in full page increments in response to inputs that represent navigation requests. In another implementation, the document representation presents a single page within the interface screen 200 at a time, and document navigation requests cause the document representation to be updated to display content from a different page from the same document.

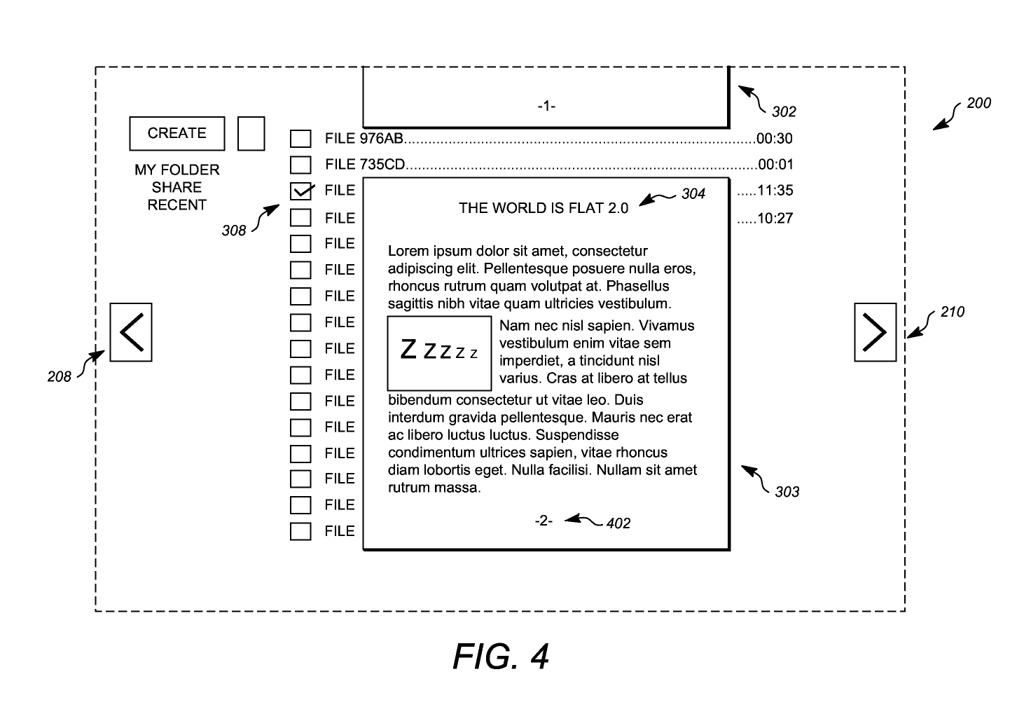

FIG. 4 the interface screen 200 for two-dimensional document navigation subsequent to receiving the document navigation request while the document preview view from FIG. 3 was output for display. The active document representation now displays content from the second document such that part, but not all, of the first page 302 of the second document is visible in the interface screen 200 and all of the second page 303 of the second document is visible in the interface view. The second page 303 of the second document, includes a heading 304, a “zzz” picture, a page number 402 (“-2-”) and relevant text.

In the example in FIG. 4, the user can continue to scroll up or down on the active document representation by user inputs representing document navigation requests. This allows content from other pages of the second document to be viewed. Alternatively, the user can change to a different document by inputs representing document change requests, such as operation of the left arrow 208 or the right arrow 210.

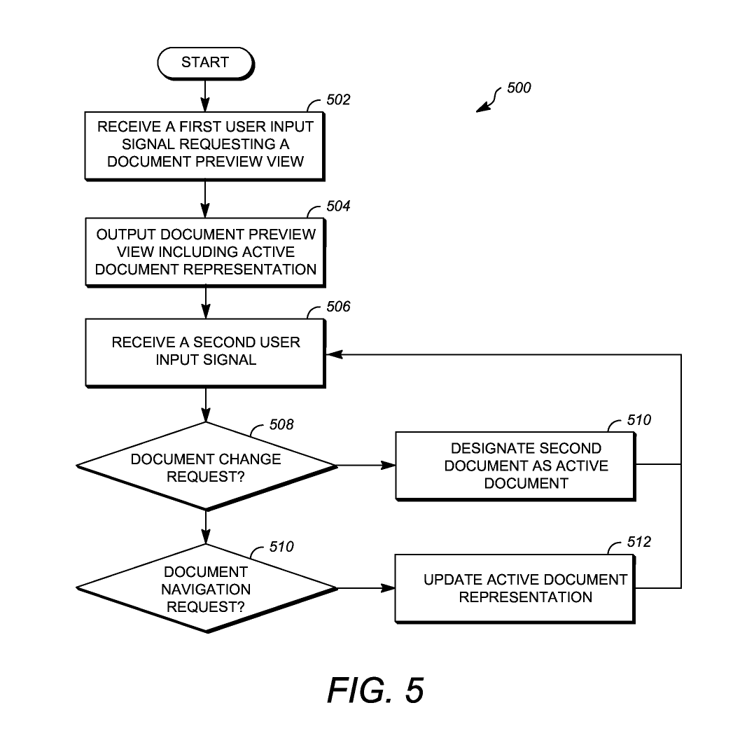

FIG. 5 is a flow chart showing an example process 500 for two-dimensional document navigation. The operations described in connection with the process 500 can be performed at one or more computers, such as computing device 100. When an operation is performed by one or more computers, it is completed when it is performed by one computer. The operations described in connection with the process 500 can be embodied as a non-transitory computer readable storage medium including program instructions executable by one or more processors that, when executed, cause the one or more processors to perform the operations. For example, the operations described in connection with the process 500 could be stored at the memory 104 of the computing device 100 and be executable by the CPU 102 thereof.

Initially, a document list view can be output for display, including information that identifies a plurality of documents. At operation 502, a first user input signal requesting a document preview view of the plurality of documents is received, such as at the computing device 100. The plurality of documents can include at least a first document and a second document, one of which is designated by as an active document, either by a selection made automatically on any suitable criteria, or in response to a user input. As an example, the first user input can indicate a selection of a first document as the active document. The first user input can be generated using input device 118, for example, a keyboard, touchscreen, or other device capable of use to generate text within an electronic document application. The first user input signal can be generated, for example, in response to a user input that activates the check box 212 next to “File 735CD” on the interface screen 200, which indicates that the first document has been selected as the active document.

At operation 504, the document preview view is output for display and includes an active document representation. The active document representation includes content from the currently active document, which in this example is the first document. Content from at least a first page of the first document is output for display as part of the active document representation, for example, as shown in FIG. 2. The active document representation can be, for example, output by the CPU 102 of the computing device 100 for display at the display 116.

At operation 506, a second user input signal is received while the document preview view is displayed. The second user input can be generated, for example, in response to user operation of the input device 118 of the computing device 100 or any other suitable input device. The second user input signal can correspond to one of a document navigation request or a document change request, where the document navigation request indicates a user's desire to view a different portion of the current active document, and the document change request indicates a user's desire to designate a different document as the current active document, thereby allowing a multi-page preview of the different document.

At operation 508 and operation 510, a determination is made as to whether the second user input signal corresponds to a document navigation request or a document change request. This determination can be made based on information associated with the input signal, such as information identifying an interface element activated by the user, a key pressed by the user, or information identifying characteristics of a gesture input including location, direction, pressure, length and duration. If, at operation 508, it is determined that the second user input signal corresponds to the document change request, the process advances to operation 512. Otherwise, the process advances to operation 510. If, at operation 510, it is determined that the second user input signal corresponds to the document navigation request, the process advances to operation 514.

At operation 512, in response to determining that the second user input signal corresponds to the document change request, the second document is designated as the active document, and thus, the active document representation now includes content from the second document. In particular, in some implementations, designating the second document as the active document causes the active document representation to include content from the second document.

At operation 514, in response to determining that the second user input signal corresponds to the document navigation request, the active document representation is updated such that a different portion of the active document representation is visible in the document preview view. Thus, a first portion of content from the first document can be visible in the active document representation prior to the document navigation request, and a second portion of content from the first document can be visible in the active document representation subsequent to the document navigation request. For instance, prior to the document navigation request, part of the document representation for the active document can be positioned off of the screen, and thus not be visible in the document preview view, but the document representation for the active document can be repositioned relative to the screen in response to the document navigation request, thus making the previously non-visible portion visible within the document preview view.

The document navigation request can cause the active document representation to make visible content from the first document that was not previously visible in the document preview view. For instance, the first document can include at least a first page and a second page, and the active document representation of content from the first document includes content from the first page and the second page of the first document. In this example, prior to operation 514 a first portion of the active document representation that includes all of the first page of the first document and less than all of the second page of the first document can be visible in the document preview view. Subsequent to operation 514, a second portion of the active document representation that includes all of the second page of the first document and less than all of the first page of the first document can be visible in the document preview view. In some implementations, repositioning the active document representation includes moving the active document representation vertically with respect to the document preview view by a distance that is less than a page height of at least one of the first page of the document or the second page of the document. In other implementations, repositioning the active document representation includes moving the active document representation vertically with respect to the document preview view by a distance that is equal to a page height of at least one of the first page of the document or the second page of the document. In addition, repositioning the active document representation can include moving the active document representation vertically with respect to the document preview view from a first position to a second position.

FIGS. 6-8 show a second example user interface for two-dimensional document navigation in the form of a document preview view that can be output for display, such as at a display screen. Use and operation of the second example user interface is as described with respect to previous examples except as noted. In the second example user interface, an interface screen includes an active document representation and one or more inactive document representations. The active document representation is the document representation with respect to which document navigation requests can be made. Document navigation requests are not made with respect to inactive document representations, but a document representation can be changed from an inactive one to an active one or vice-versa in response to a document change requests. The second example user interface of FIGS. 6-8 can implement a scrolling carousel or slide type view, where document representations move laterally left-to-right or right-to-left with respect to the interface in response to inputs corresponding to document change request. The active document representation can be distinguished graphically from the inactive document representations, such as by a larger relative size for the active document representation, different coloration, a graphical element such as a border, or other types of graphical effects.

Subsequent to either of operation 512 or operation 514, the process can return to operation 506. In response to receiving a third user input signal, the document preview view can be ended. In one example, the third input signal indicates a user desire to return to the document list view, which is then output for display in response. In another example, the third input signal indicates a user desire to open a full view of the currently active document in a document viewing and/or editing application, which is then output for display in response.

In FIG. 6, a first display state 600 of the second example user interface includes an active document representation including content from a first document, namely representations of content from a first page 610 from the first document and a second page 612 from the first document. The first display state 600 also includes two inactive document representations and interface elements in the form of arrows 602, 604 for receiving document change request inputs. A first inactive document representation is positioned to the left of the active document representation including content from a second document, namely a representation of content from a first page 620 of the second document. A second inactive document representation is positioned to the right of the active document representation including content from a third document, namely a representation of content from a first page 630 of the third document.

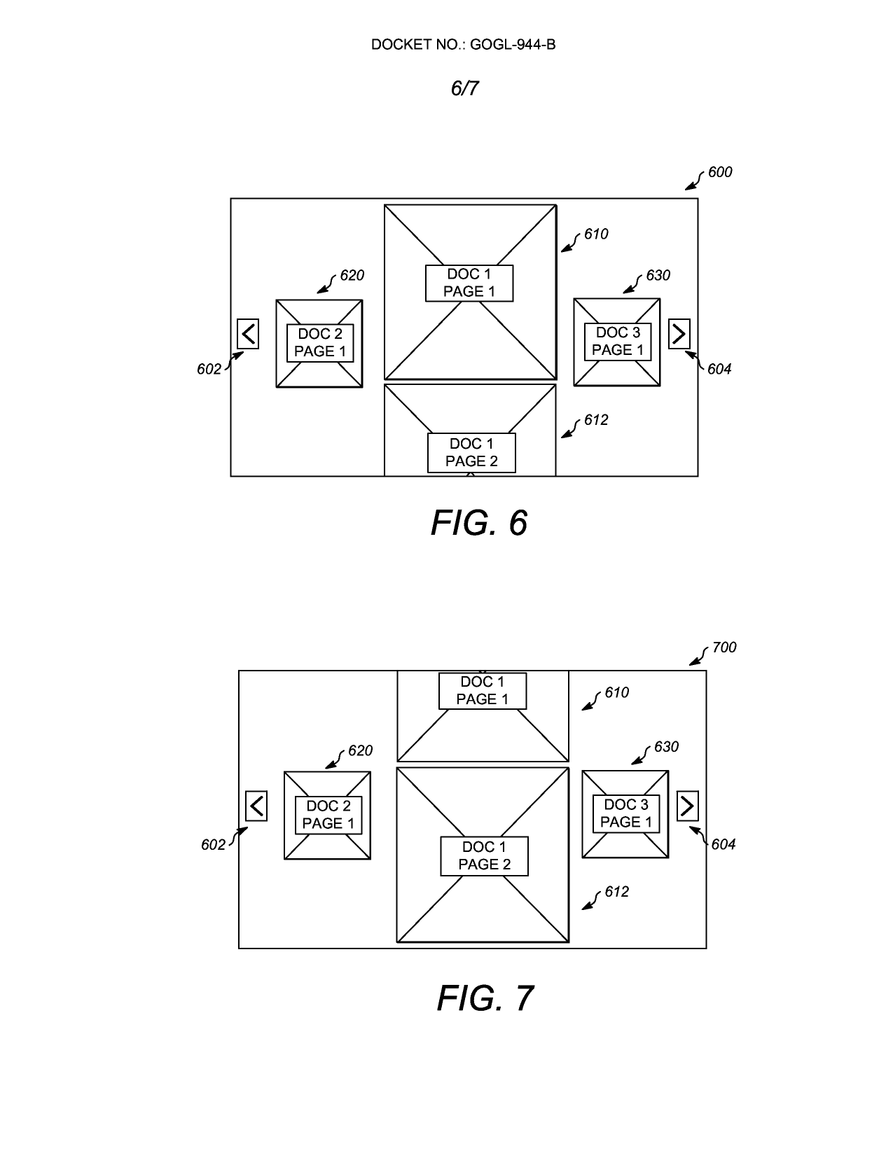

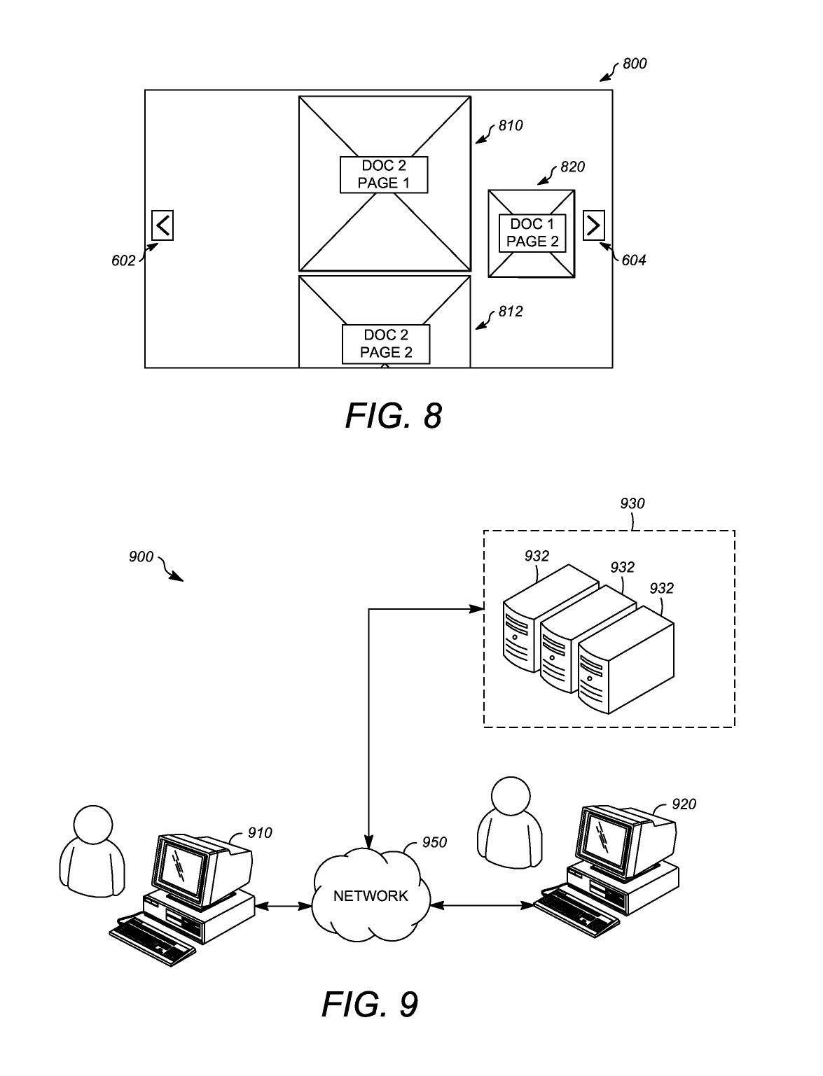

While the first display state 600 is displayed, a document navigation request can cause top-to-bottom scrolling of the active document representation. Thus repositioning the active document representation to display a different portion of content from the first document, as shown by the second display state 700 of FIG. 7. While wither of the first display state 600 or the second display state 700 are displayed a document change request can cause lateral movement of the document representations, such that a different document representation becomes the active document representation. For instance, in FIG. 8, a third display state 800 is output for display subsequent to a document change request, where an active document representation includes content from the second document, namely a representation of content from a first page 810 of the second document and a representation of content from a second page 812 of the second document. An inactive document representation that is positioned to the right of the active document representation includes content from the first document, namely a representation of content from a first page 820 of the first document.

The foregoing examples can be implemented in the form of software executed solely at the computing device 100, with the user interfaces being output for display at the computing device 100.

The computing device 100 (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably. Further, portions of computing device 100 do not necessarily have to be implemented in the same manner.

In one embodiment, the computing device 100 can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

The foregoing examples can also be implemented using a client-server model. For instance, FIG. 9 shows an example of an environment 900 in which a system for two-dimensional document navigation can be implemented. The environment 900 can include a user system 910, one or more additional user systems 920, and an application hosting service 930. The user system 910 and the additional user systems 920 are each representative of a large number (e.g. millions) of systems that can be included in the environment 900, with each system being able to utilize one or more applications that are provided by the application hosting service 930. The user system 910 and the additional user systems 920 can each be any manner of computer or computing device, such as a desktop computer, a laptop computer, a tablet computer, or a smart-phone (a computationally-enabled mobile telephone). The application hosting service 930 can be implemented using one or more server computers 932. The user system 910, the additional user systems 920, and the application hosting service 930 can each be implemented as a single system, multiple systems, distributed systems, or in any other form. As an example, the user system 910, the additional user systems 920, and the application hosting service 930 can each be implemented using the hardware configuration described previously with respect to the computing device 100 of FIG. 1.

The systems, services, servers, and other computing devices described here are in communication via a network 950. The network 950 can be one or more communications networks of any suitable type in any combination, including wireless networks, wired networks, local area networks, wide area networks, cellular data networks, and the internet.

The application hosting service 930 can provide access to one or more hosted applications to a defined group of users including operators associated with the user system 910 and the additional user systems 920. The hosted applications can include an online document storage system that implements two-dimensional navigation according to the previously-described examples. As an example, the documents can be stored at the application hosting service, and the user interfaces can be output for display at the user system 910 by transmission of information from the application hosting service to the user system 910 via the network 950 where the information, when interpreted by the user system 910 causes the interfaces to be output for display at the user system 910. User inputs received at the user system 910 can be processed locally using computer program instructions provided to the user system 910 by the application hosting service 930, or can be transmitted to the application hosting service 930 via the network for processing at the application hosting service.

Further, all or a portion of embodiments can take the form of a computer program product accessible from, for example, a non-transitory computer-usable or computer-readable medium. A non-transitory computer-usable or computer-readable medium can be any device that can, for example, tangibly contain, store, communicate, or transport the program for use by or in connection with any processor. The non-transitory medium can be, for example, an electronic device, magnetic device, optical device, electromagnetic device, or a semiconductor device. Other suitable mediums are also available.

While this disclosure includes what is presently considered to be the most practical and preferred embodiments, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method, comprising:
receiving a first user input signal requesting a document preview view of a plurality of documents from a document list that includes at least a first document and a second document, wherein the first document is designated as an active document;
in response to the first user input signal, outputting for display the document preview view including an active document representation of content from the first document, wherein a first portion of the active document representation is visible in the document preview view;
receiving, while the preview view is displayed, a second user input signal;
determining whether the second user input signal corresponds to a document navigation request or a document change request;
in response to determining that the second user input signal corresponds to the document navigation request, repositioning the active document representation such that a second portion of the active document representation is visible in the document preview view; and
in response to determining that the second user input signal corresponds to the document change request, designating the second document as the active document.

2. The method of claim 1, wherein the first document includes at least a first page and a second page, and the active document representation of content from the first document includes content from the first page and the second page of the first document.

3. The method of claim 2, wherein the first portion of the active document representation includes all of the first page of the first document and less than all of the second page of the first document, and the second portion of the active document representation includes all of the second page of the first document and less than all of the first page of the first document.

4. The method of claim 2, wherein repositioning the active document representation includes moving the active document representation vertically with respect to the document preview view by a distance that is less than a page height of at least one of the first page of the document or the second page of the document.

5. The method of claim 1, wherein repositioning the active document representation includes moving the active document representation vertically with respect to the document preview view from a first position to a second position.

6. The method of claim 1, wherein designating the second document as the active document causes the active document representation to include content from the second document.

7. The method of claim 1, further comprising:
outputting, for prior to receiving the first user input signal, a document list view that includes information that identifies the plurality of documents.

8. The method of claim 1, further comprising:
in response to the first user input signal, outputting for display the document preview view further including an inactive document representation of content from the second document, wherein the inactive document representation is graphically distinguished from the active document representation.

9. A non-transitory computer-readable storage device including program instructions executable by one or more processors that, when executed, cause the one or more processors to perform operations, the operations comprising:
receiving a first user input signal requesting a document preview view of a plurality of documents from a document list that includes at least a first document and a second document, wherein the first document is designated as an active document;
in response to the first user input signal, outputting for display the document preview view including an active document representation of content from the first document, wherein a first portion of the active document representation is visible in the document preview view;
receiving, while the preview view is displayed, a second user input signal;
determining whether the second user input signal corresponds to a document navigation request or a document change request;
in response to determining that the second user input signal corresponds to the document navigation request, repositioning the active document representation such that a second portion of the active document representation is visible in the document preview view; and
in response to determining that the second user input signal corresponds to the document change request, designating the second document as the active document.

10. The non-transitory computer-readable storage device of claim 9, wherein the first document includes at least a first page and a second page, and the active document representation of content from the first document includes content from the first page and the second page of the first document.

11. The non-transitory computer-readable storage device of claim 10, wherein the first portion of the active document representation includes all of the first page of the first document and less than all of the second page of the first document, and the second portion of the active document representation includes all of the second page of the first document and less than all of the first page of the first document.

12. The non-transitory computer-readable storage device of claim 10, wherein repositioning the active document representation includes moving the active document representation vertically with respect to the document preview view by a distance that is less than a page height of at least one of the first page of the document or the second page of the document.

13. The non-transitory computer-readable storage device of claim 9, wherein repositioning the active document representation includes moving the active document representation vertically with respect to the document preview view from a first position to a second position.

14. The non-transitory computer-readable storage device of claim 9, wherein designating the second document as the active document causes the active document representation to include content from the second document.

15. The non-transitory computer-readable storage device of claim 9, further comprising:
outputting, for prior to receiving the first user input signal, a document list view that includes information that identifies the plurality of documents.

16. The non-transitory computer-readable storage device of claim 9, further comprising:
in response to the first user input signal, outputting for display the document preview view further including an inactive document representation of content from the second document, wherein the inactive document representation is graphically distinguished from the active document representation.

17. An apparatus, comprising:
one or more processors; and
one or more memory devices for storing program instructions used by the one or more processors, wherein the program instructions, when executed by the one or more processors, cause the one or more processors to:
receive a first user input signal requesting a document preview view of a plurality of documents from a document list that includes at least a first document and a second document, wherein the first document is designated as an active document;
in response to the first user input signal, output for display the document preview view including an active document representation of content from the first document, wherein a first portion of the active document representation is visible in the document preview view;
receive, while the preview view is displayed, a second user input signal;
determine whether the second user input signal corresponds to a document navigation request or a document change request;
in response to a determination that that the second user input signal corresponds to the document navigation request, reposition the active document representation such that a second portion of the active document representation is visible in the document preview view; and
in response to a determination that that the second user input signal corresponds to the document change request, designate the second document as the active document.

18. The apparatus of claim 17, wherein the first document includes at least a first page and a second page, and the active document representation of content from the first document includes content from the first page and the second page of the first document.

19. The apparatus of claim 18, wherein the first portion of the active document representation includes all of the first page of the first document and less than all of the second page of the first document, and the second portion of the active document representation includes all of the second page of the first document and less than all of the first page of the first document.

20. The apparatus of claim 18, wherein repositioning the active document representation includes moving the active document representation vertically with respect to the document preview view by a distance that is less than a page height of at least one of the first page of the document or the second page of the document.

21. The apparatus of claim 17, wherein repositioning the active document representation includes moving the active document representation vertically with respect to the document preview view from a first position to a second position.

22. The apparatus of claim 17, wherein designating the second document as the active document causes the active document representation to include content from the second document.

23. The apparatus of claim 17, wherein the program instructions, when executed by the one or more processors, further cause the one or more processors to:
output, for prior to receiving the first user input signal, a document list view that includes information that identifies the plurality of documents.

24. The apparatus of claim 17, wherein the program instructions, when executed by the one or more processors, further cause the one or more processors to:
in response to the first user input signal, output for display the document preview view further including an inactive document representation of content from the second document, wherein the inactive document representation is graphically distinguished from the active document representation.
